(19) United States
(12) Patent Application Publication
(10) Pub. No.: US 2024/0402357 A1
(43) Pub. Date: Dec. 5, 2024

(54) MULTI-SATELLITE-RECEIVER POWER CONTROL

(71) Applicant: QUALCOMM Incorporated, San Diego, CA (US)

(72) Inventor: Rayman PON, Cupertino, CA (US)

(21) Appl. No.: 18/327,944

(22) Filed: Jun. 2, 2023

(51) Int. Cl. G01S 19/34; G01S 19/33

(52) U.S. Cl. CPC G01S 19/34; G01S 19/33

(57) ABSTRACT

A user equipment includes: a first receive chain configured to receive and output satellite positioning signals in a first frequency band; a second receive chain configured to receive and output satellite positioning signals in a second frequency band; one or more memories; and one or more processors communicatively coupled to the first receive chain, the second receive chain, and the one or more memories, the one or more processors being configured to measure signal conditions of the satellite positioning signals in the first frequency band and the second frequency band; determine whether the measured signal conditions meet positioning performance criteria; and cause, based on the measured signal conditions meeting the positioning performance criteria, the first receive chain to duty cycle between a first state and a second state and the second receive chain to be in the first state during the duty cycling of the first receive chain.

### BACKGROUND

Satellite positioning system receivers may be included in various devices, such as mobile devices, for receiving and measuring satellite positioning signals, from which positions of the devices may be determined using the satellite positioning signals. Each satellite positioning system receiver requires and consumes power. To reduce power consumption, the receive chains of the satellite positioning system receiver may be duty cycled, where power is supplied to each receive chain for a fraction of a time interval. During each fraction of a time interval, each receive chain is able to obtain measurements from the satellite positioning signals.

### SUMMARY

In an example embodiment, a user equipment includes: a first receive chain configured to receive and output satellite positioning signals in a first frequency band; a second receive chain configured to receive and output satellite positioning signals in a second frequency band; one or more memories; and one or more processors communicatively coupled to the first receive chain, the second receive chain, and the one or more memories, the one or more processors being configured to measure signal conditions of the satellite positioning signals in the first frequency band and the second frequency band; determine whether the measured signal conditions meet positioning performance criteria; and cause, based on the measured signal conditions meeting the positioning performance criteria, the first receive chain to duty cycle between a first state and a second state and the second receive chain to be in the first state during the duty cycling of the first receive chain.

In another example embodiment, a satellite signal processing method includes: measuring signal conditions of satellite positioning signals received using a first receive chain configured to receive and output satellite positioning signals in a first frequency band and a second receive chain configured to receive and output satellite positioning signals in a second frequency band; determining whether the measured signal conditions meet positioning performance criteria; and causing, based on the measured signal conditions meeting the positioning performance criteria, the first receive chain to duty cycle between a first state and a second state and the second receive chain to be in the first state during the duty cycling of the first receive chain.

In another example embodiment, a user equipment includes: means for measuring signal conditions of satellite positioning signals received using a first receive chain configured to receive and output satellite positioning signals in a first frequency band and a second receive chain configured to receive and output satellite positioning signals in a second frequency band; means for determining whether the measured signal conditions meet positioning performance criteria; and means for, causing, based on the measured signal conditions meeting the positioning performance criteria, the first receive chain to duty cycle between a first sate and a second state and the second receive chain to be in the first state during the duty cycling of the first receive chain.

In another example embodiment, a non-transitory, processor-readable storage medium includes processor-readable instructions to cause one or more processors of a user equipment to: measure signal conditions of satellite positioning signals received using a first receive chain configured to receive and output satellite positioning signals in a first frequency band and a second receive chain configured to receive and output satellite positioning signals in a second frequency band; determine whether the measured signal conditions meet positioning performance criteria; and cause, based on the measured signal conditions meeting the positioning performance criteria, the first receive chain to duty cycle between a first state and a second state and the second receive chain to be in the first state during the duty cycling of the first receive chain.

### BRIEF DESCRIPTION OF THE DRAWINGS

FIG. 1 is a simplified diagram of an example wireless communications system.

FIG. 2 is a frequency band plot of satellite signals and frequencies of the satellite signals.

FIG. 3 is a simplified block diagram of an example user equipment.

FIGS. 4A-4B are block flow diagrams of a first embodiment of a method for satellite signal processing.

FIG. 5 is a block diagram of a first example of ON times for a first receive chain and a second receive chain.

FIG. 6 is a block flow diagram of a second embodiment of a method for satellite signal processing.

FIG. 7 is a block flow diagram of a third embodiment of a method for satellite signal processing.

FIG. 8 is a block diagram of a second example of ON times for a first receive chain and a second receive chain.

FIG. 9 is a block flow diagram of a fourth embodiment of a method for satellite signal processing.

FIG. 10 is a block diagram of a third example of ON times for a first receive chain and a second receive chain.

FIG. 11 is a block flow diagram of a fifth embodiment of a method for satellite signal processing.

FIG. 12 is a block diagram of a fourth example of ON times for a first receive chain and a second receive chain.

FIG. 13 is a block flow diagram of a sixth embodiment of a method for satellite signal processing.

FIG. 14 is a block diagram of a fifth example of ON times for a first receive chain and a second receive chain.

FIG. 15 is a block flow diagram of a seventh embodiment of a method for satellite signal processing.

FIG. 16 is a block diagram of a sixth example of ON times for a first receive chain and a second receive chain.

FIG. 17 is a block flow diagram of an eighth embodiment of a method for satellite signal processing.

FIG. 18 is a block diagram of a seventh example of ON times for a first receive chain and a second receive chain.

### DETAILED DESCRIPTION

Techniques are discussed herein for power control in multi-satellite receivers, where a user equipment includes a first receive chain configured to receive and output satellite positioning signals in a first frequency band and a second receive chain configured to receive and output satellite positioning signals in a second frequency band. The satellite positioning signals may be used by the user equipment to determine a position (location) of the user equipment. The signal conditions of the satellite positioning signals, as received by the first and second receive chains, are measured and compared with positioning performance criteria. The positioning performance criteria may vary depending on the positioning accuracy and/or precision requirements of an application invoked on the user equipment. The first receive chain is caused to be duty cycled, and the second receive chain is caused to be continuously ON between at least two consecutive ON times of the first receive chain, based on the measured signal conditions meeting the positioning performance criteria. Configured in this manner, power is supplied to the first receive chain for a fraction of a time interval while power is continuously supplied to the second receive chain for the time interval. Should the measured signal conditions change, such that the positioning performance criteria are no longer met, the mode of operation of the first receive chain may be changed, e.g., to be continuously ON.

Items and/or techniques described herein may provide one or more of the above capabilities, as well as other capabilities not mentioned. Power consumption by satellite signal receivers is conserved while retaining measurement observable quality and maintaining carrier phase observables consistent with the positioning performance criteria required by one or more applications executing on the user equipment. With the first receive chain configured to be duty cycled and the second receive chain configured to be continuously ON between at least two consecutive ON times of the first receive chain, the degradation in measurement observable quality may be less than when both the first and second receive chains are duty cycled. A continuous carrier phase observable for a first receive chain can be reconstructed using observables from satellite positioning signals received by a second receive chain, for the same satellite vehicle. Other capabilities may be provided and not every implementation according to the disclosure must provide any, let alone all, of the capabilities discussed.

Obtaining the locations of mobile devices may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs).

The description herein may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

As used herein, the terms “user equipment” (UE) are not specific to or otherwise limited to any particular Radio Access Technology (RAT), unless otherwise noted. In general, a UE may be any wireless communication device (e.g., a mobile phone, router, tablet computer, laptop computer, consumer asset tracking device, Internet of Things (IoT) device, etc.) used to communicate over a wireless communications network. A UE may be mobile or may (e.g., at certain times) be stationary. As used herein, the term “UE” may be referred to interchangeably as a “client device,” a “wireless device,” a “mobile device,” or variations thereof. UEs may be embodied by any of a number of types of devices including but not limited to printed circuit (PC) cards, compact flash devices, external or internal modems, wireless or wireline phones, smartphones, tablets, consumer asset tracking devices, asset tags, and so on. The UE 105 may be, e.g., an IoT device, a location tracker device, a cellular telephone, a vehicle (e.g., a car, a truck, a bus, a boat, etc.), or another device.

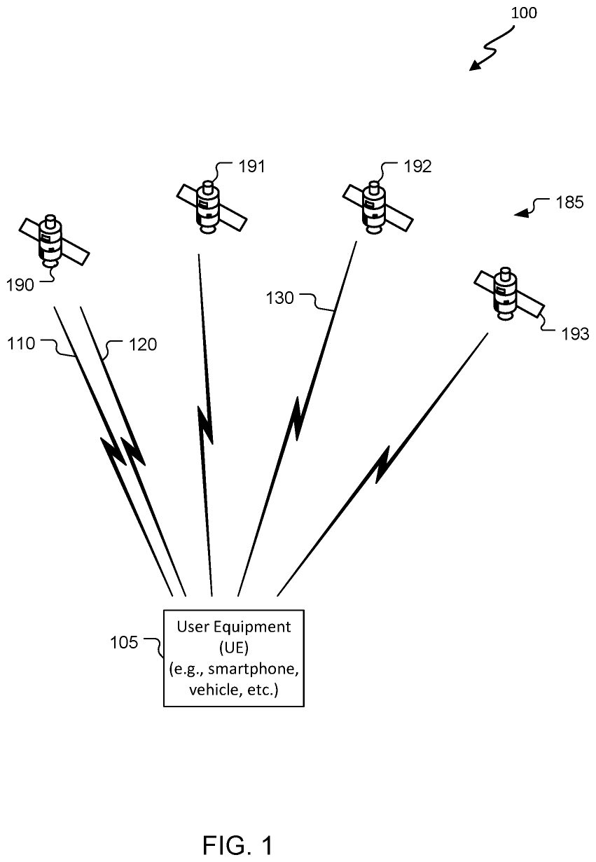

Referring to FIG. 1, an example of a communication system 100 that includes a UE 105. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). The communication system 100 may include additional or alternative components.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

### Multi-Frequency Band Satellite Signal Processing

Multi-frequency GNSS uses satellite signals from different frequency bands to determine desired information such as pseudoranges, position estimates, and/or time. Using multi-frequency GNSS may provide better performance (e.g., position estimate speed and/or accuracy) than single-frequency GNSS for certain qualified conditions. Using multi-frequency GNSS typically uses more power than single-frequency GNSS, e.g., processing power and battery power (e.g., to power a processor (e.g., for determining measurements), baseband processing, and/or RF processing). Techniques discussed herein obtain information using multi-frequency GNSS while using less power than full-time, multi-frequency GNSS. Techniques discussed herein may be able to maintain performance (e.g., position estimation accuracy) similar to full-time, multi-frequency GNSS with reduced power.

Referring again to FIG. 1, in communications system 100, the UE 105 may receive satellite signals from the satellites 190-193. The satellites 190-193 are members of the constellation 185, i.e., a group of satellites that are part of a system, e.g., controlled by a common entity such as a government, and orbiting in complementary orbits to facilitate determining positions of entities around the world. The satellites 190-193 may be, for example, members of the BPS, Galileo, Beidou, GLONASS, or QZSS constellation. The satellites 190-193 may each transmit multiple satellite signals in different frequency bands, e.g., the satellite 190 may transmit a satellite signal 110 and a satellite signal 120 that have frequencies in different frequency bands, e.g., L1 and L2/L5 frequency bands, the satellites 191 and 193 may transmit signals in the same frequency bands (not shown), and a satellite signal 130 from the satellite 192 may have a frequency in only one frequency band, e.g., the L1 frequency band.

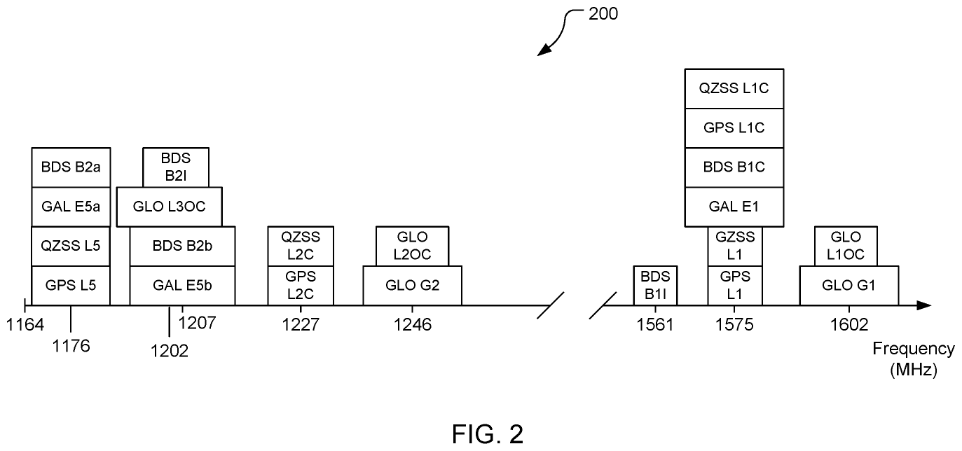

Referring also to FIG. 2 (which, like other figures, is not shown to scale), a frequency band plot 200 shows that GNSS constellations operate on several frequencies in the L-Band. The L1 frequency band typically covers frequencies from 1559 MHz to 1606 MHz and includes L1 signals from GPS, Galileo, Beidou, GLONASS, and QZSS GNSS constellations. These same constellations also transmit concurrently using another frequency in the L2 frequency band and/or the L5 frequency band. The L2 and L5 signals may complement the L1 signals, which have been used for many years. For example, the L5 signals have wider signal bandwidth than the L1 signals, which helps improve positioning performance in multi-path environments. Also, using the L5 signals in addition to the L1 signals provides frequency diversity. The L2 and L5 signals are far enough away in frequency from the L1 signals that different processing paths may be used to measure the L2 and L5 signals versus the L1 signals. While the discussion herein focuses on the L1, L2, and L5 bands, the discussion (including the claims) are not limited to these bands, nor is the discussion limited to the use of satellite signals in two or three bands.

Multiple satellite bands are allocated to satellite usage. These bands include the L-band, used for GNSS satellite communications, the C-band, used for communications satellites such as television broadcast satellites, the X-band, used by the military and for RADAR applications, and the Ku-band (primarily downlink communication and the Ka-band (primarily uplink communications), the Ku and Ka bands used for communications satellites. The L-band is defined by IEEE as the frequency range from 1 to 2 GHz. The L-Band is utilized by the GNSS satellite constellations such as GPS, Galileo, GLONASS, and BeiDou, and is broken into five bands, the L1 Band: 1575.42 MHz, L2: 1227.60 MHz. L3 Band: 1381.05 MHz, LS Band: 1176.45 MHz. For location purposes, the L1 band has historically been used by commercial GNSS receivers. However, measuring GNSS signals across more than one band may provide for improved accuracy and availability.

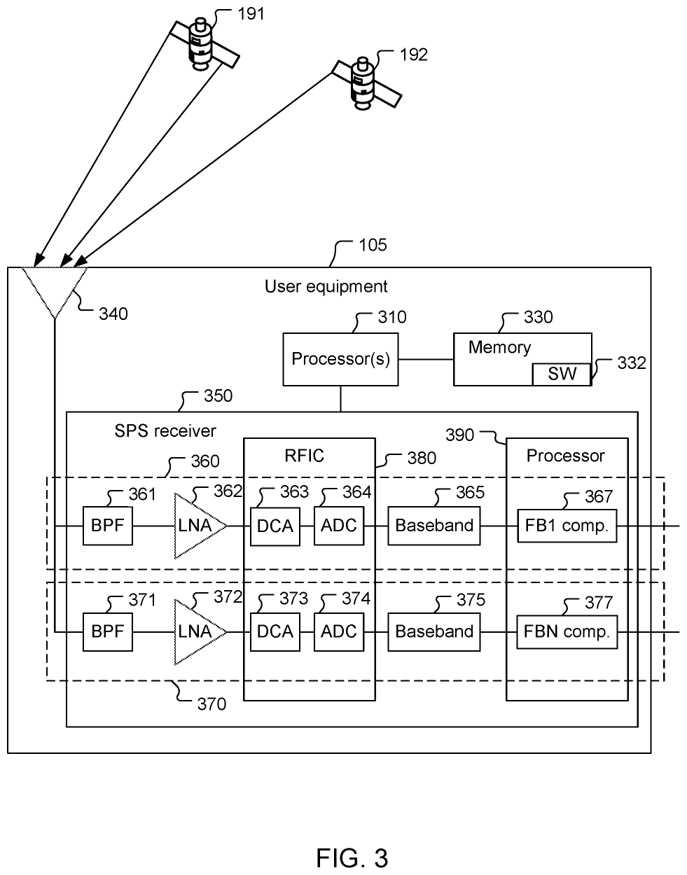

Referring to FIG. 3, the UE 105 may include a processor 310, a memory 330, an antenna 340, and an SPS receiver 350 communicatively coupled to each other. The processor 310 may include more intelligent hardware devices, e.g., a central processing unit (CPU), a microcontroller, an application specific integrated circuit (ASIC), etc. The processor 310 may comprise multiple processors and/or the memory 330 may include multiple memories. The processor 310 may be configured to control components of the SPS receiver 350, e.g., activation status (whether a component (including a portion of a component) is active (e.g., powered or enabled for operation) or inactive (e.g., unpowered or disabled from operation)). The processor 310 may be configured to perform one or more functions for controlling activation status of receive chains of the UE 105 for measuring one or more satellite signals or disabling measurement of one or more satellite signals. Receive chains may be referred to as RF paths (radio frequency paths). The memory 330 may be a non-transitory storage medium that may include random access memory (RAM), flash memory, disc memory, and/or read-only memory (ROM), etc. The memory 330 may store software 332 which may be processor-readable, processor-executable software code containing instructions that may be configured to, when executed, cause the processor 310 to perform various functions described herein. Alternatively, the software 332 may not be directly executable by the processor 310 but may be configured to cause the processor 310. e.g., when compiled and executed, to perform the functions. The description herein may refer to the processor 310 performing a function, but this includes other implementations such as where the processor 310 executes software and/or firmware. The processor 310 may include a memory with stored instructions in addition to and/or instead of the memory 330. The antenna 340 is configured to receive satellite signals of different frequency bands, and the antenna 340 may include one or more antennas and/or antenna elements. The SPS receiver 350 (e.g., a Global Positioning System (GPS) receiver) may be capable of receiving and acquiring SPS signals via an SPS antenna 340. The SPS antenna 340 may configured to transduce the SPS signals from wireless signals to guided (e.g., wired) signals, e.g., electrical or optical signals, and may be integrated with the antenna 340. The SPS receiver 350 may be configured to process, in whole or in part, the acquired SPS signals for estimating a location of the UE 105. For example, the SPS receiver 350 may be configured to determine location of the UE 105 by trilateration using the SPS signals.

The SPS receiver 350 includes multiple receive chains 360, 370 for measuring satellite signals. The satellite signals may have the same frequency or different frequencies, and/or may be in the same range of frequencies, in different but overlapping ranges of frequencies (with one or more shared frequencies), or in separate (non-overlapping) ranges of frequencies (with no shared frequency). The satellite signals may include multiple basebands or a single baseband attached to multiple receive chains 360, 370. The discussion herein refers to the receive chains 360, 370 being for different frequency bands, but this is an example and not limiting of the disclosure, including the claims. Further, while two receive chains are shown in FIG. 3, the UE 105 may include more than two receive chains, e.g., for measuring satellite signals having frequencies in more than two different frequency bands (e.g., different sub-bands). The receive chains 360, 370 may, for example, be configured to measure satellite signals in the L1 and L2/L5 bands, respectively, although this is an example and not limiting of the disclosure as either or both of the receive chains 360, 370 may be configured to measure signals of other frequencies or frequency bands, and/or other receive chains may be included in the UE 105.

The receive chains 360, 370 each include respective components for measuring satellite signals, in this example, of different frequency bands. The receive chain 360 includes a BPF 361 (bandpass filter), an LNA 362 (low-noise amplifier), a DCA 363 (Digital Controlled Amplifier for down-conversion, signal conditioning/filtering, and amplification), an ADC 364 (analog-to-digital converter), a baseband block 365, and a computational block 367. The BPF 361 is configured to pass signals of frequencies within a desired frequency band, e.g., the L1 band, with little if any attenuation, and to significantly attenuate signals of frequencies outside the desired frequency band of the BPF 361. The LNA 362 is configured to amplify signals passed by the BPF 361. The DCA 363 is configured to down convert the analog amplified signals output by the LNA 362 to a baseband frequency, to perform signal conditioning and/or filtering (e.g., anti-aliasing filtering), and amplification in addition to the amplification by the LNA 362. The ADC 364, which here is a portion of an RFIC 380 (Radio Frequency Integrated Circuit), is configured to convert the analog signals output by the DCA 363 into digital signals. The baseband block 365 is configured to perform intense signal processing of correlating the digital signals output by the ADC 364 with respective reference pseudorandom signals (e.g., Gold codes) by integrating the signals (e.g., for 1 ms) and dumping the integrated signals for further processing to determine whether the correlation results have sufficient energy to indicate a true signal. The computational block 367, which here is a portion of a processor 390, is configured to perform one or more computations on the signals output by the baseband block 365 to determine one or more satellite signal parameters (e.g., pseudorange, CNo (carrier-to-noise-density ratio), Doppler, carrier phase, etc.). The computational block 367 comprises a portion of the processor 390 for performing computations for the receive chain 360, namely corresponding to signals in the desired frequency band of the BPF 361. Thus, the computational block 367 is shown as being for computation for frequency band 1 (FB1). The receive chain 370 includes a BPF 371, an LNA 372, a DCA 373, an ADC 374, a baseband block 375, and a computational block 377. The BPF 371 is configured to pass signals of frequencies within a desired frequency band, e.g., the L2/L5 band, with little if any attenuation, and to significantly attenuate signals of frequencies outside the desired frequency band of the BPF 371. The LNA 372, DCA 373, ADC 374, baseband block 375, and computational block 377 are configured similarly to the LNA 362, DCA 363, ADC 364, baseband block 365, and computational block 367, but configured, as appropriate, for processing signals corresponding to signals of the desired frequency of the BPF 371. Thus, the computational block 377 is shown as being for computation for frequency band N (FBN), as there may be N receive chains, with N being an integer of two or greater.

The receive chains 360, 370 are distinct and may be activated/deactivated independently. Although the DCAs 363, 373 and the ADCs 364, 374 are parts of the RFIC 380, the DCA 363 and the ADC 364 comprise a portion of the RFIC 380 and the DCA 373 and the ADC 374 comprise a different portion of the RFIC 390, e.g., such that the DCA 363 and the ADC 364 may be enabled/disabled independently of enablement/disablement of the DCA 373 and the ADC 374. Similarly, the computational block 367 comprises a portion of the processor 390 and the computational block 377 comprises a different portion of the processor 390 such that the computational blocks 367, 377 may be enabled/disabled independently. For example, processing by the computational block 367 may be performed while processing by the computational block 377 may be avoided, thus saving power that would be used to perform computations by the computational block 377. Each of the receive chains 360, 370 may be controlled by the processor 310 to be active, e.g., with the BPF 361, the LNA 362, the DCA 363, the ADC 364, the baseband block 365, and the computational block 367 powered and/or with the BPF 371, the LNA 372, the DCA 373, the ADC 374, the baseband block 375, and the computational block 377 powered. Similarly, each of the receive chains 360, 370 may be controlled by the processor 310 to be inactive, e.g., with one or more of the BPF 361, the LNA 362, the DCA 363, the ADC 364, the baseband block 365, and the computational block 367 not powered or otherwise not used (e.g., the computational block 367 not provided with data to process) and/or with one or more of the BPF 371, the LNA 372, the DCA 373, the ADC 374, the baseband block 375, and the computational block 377 not powered or otherwise not used.

To reduce power consumption, each receive chain 360, 370 can be duty cycled, where each receive chain 360, 370 is ON (i.e., power supplied to a receive chain) for a fraction of a time interval. The operation of each receive chain 360, 370 may be implemented by a respective instruction from the processor 310, e.g., to duty cycle, to turn OFF, to be continuously ON, etc. While duty cycled, the receive chains 360, 370 consume less power than if the receive chains 360, 370 were continuously ON.

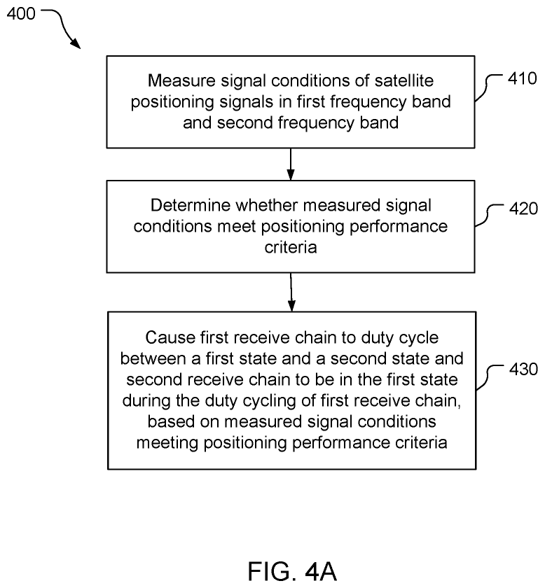

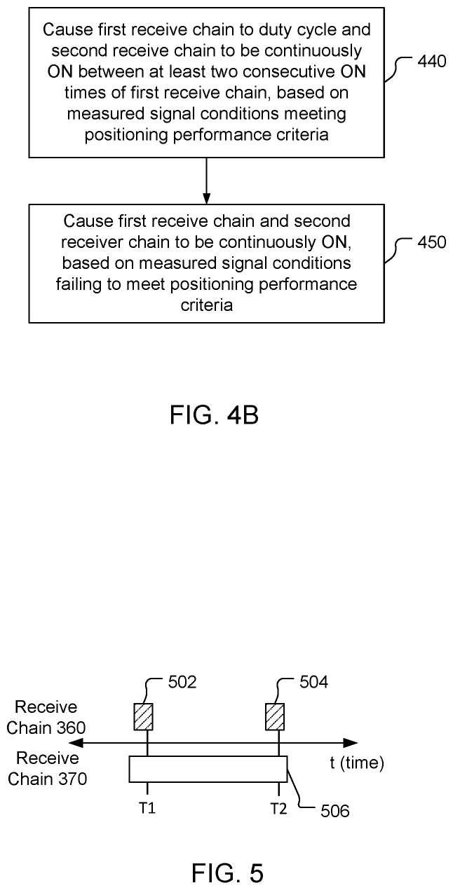

FIGS. 4A, 4B, and 5 illustrate an embodiment of a method 400 for satellite signal processing, e.g., to conserve power in a multi-band satellite receiver. In the SPS receiver 350, the processor 310 activates both the first receive chain 360 and the second receive chain 370. The first receive chain 360 is configured to receive and output satellite positioning signals in a first frequency band (e.g., L1), and the second receive chain 370 is configured to receive and output satellite positioning signals in a second frequency band (e.g., L2/L5). In an example embodiment, the operation of the receive chains 360, 370 are initially implemented by a respective instruction from the processor 310 to be continuously ON. Referring to FIG. 4A, the processor 310 measures signal conditions of the satellite positioning signals in the first frequency band and the second frequency band (block 410). The processor 310 determines whether the measured signal conditions meet positioning performance criteria (block 420). The processor 310, possibly in combination with the memory 330, may comprise means for measuring the signal conditions of the satellite positioning signals and means for determining whether the measured signal conditions meet positioning performance criteria. The processor 310 causes (e.g., via an instruction from the processor 310) the first receive chain 360 to duty cycle between a first state and a second state and causes (e.g., via another instruction from the processor 310) the second receive chain 370 to be in the first state during the duty cycling of the first receive chain 360, based on the measured signal conditions meeting the positioning performance criteria (block 430). The processor 310 may repeat blocks 410, 420, and 430. The first state may be ON, and the second state may be OFF. Referring to FIG. 4B, in an example embodiment, the processor 310 causes the second receive chain 370 to be continuously ON between at least two consecutive ON times of the first receive chain 360, based on the measured signal conditions meeting the positioning performance criteria (block 440). The processor 310 may cause the first and second receive chains 360, 370 to be continuously ON based on the measured signal conditions failing to meet the positioning performance criteria (block 450). For example, in FIG. 5, a time interval begins at time instance T1 and ends at time instance T2. Time instance T2 is also the beginning of the next time interval. Segments 502 and 504 in FIG. 5 represent times during which the first receive chain 360 is ON (i.e., power is supplied to and reaches the first receive chain 360. When the first receive chain 360 is duty cycled, a gap exists between segments 502 and 504 when the first receive chain 360 is OFF (i.e., power is not supplied to or power is prevented from reaching one or more components of the receive chain 360). When duty cycled, the first receive chain 360 is ON for a fraction of each time interval. The processor 310 causes the second receive chain 370 to be continuously ON between at least two consecutive ON times of the first receive chain 360. For example, segment 506 in FIG. 5 represents times during which the second receive chain 370 is continuously ON between segments 502 and 504. Because the first receive chain 360 is duty cycled, the power consumption by the first receive chain 360 is reduced compared to being continuously ON. Since the second receive chain 370 is continuously ON between at least two consecutive ON times of the first receive chain 360, the degradation in measurement observable quality may be less than when both the first and second receive chains 360, 370 are duty cycled. Further, the carrier phase observable for the first receive chain 360 can be reconstructed using the observables from the satellite positioning signals received by the second receive chain 370 for the same SV. A reduction in power consumption may be realized with at least one of the receive chains 360, 370 being duty cycled as compared to both of the receive chains 360, 370 being continuously ON (not duty cycled). A higher positioning performance may be realized with both of the receive chains 360, 370 being continuously ON as compared to both of the receive chains 360, 370 being duty cycled. By causing the second receive chain 370 to be continuously ON, ongoing carrier phase on the second frequency band may be measured for faster integer ambiguity resolution and/or faster convergence for RTK (Real Time Kinematic) or PPP (Precise Point Positioning), respectively, compared to having both of the receive chains 360, 370 duty cycled. The processor 310, possibly in combination with the memory 330, in combination with the first receive chain 360 may comprise means for duty cycling the first receive chain 360. The processor 310, possibly in combination with the memory 330, in combination with the second receive chain 370 may comprise means for causing the second receive chain 370 to be continuously ON between consecutive ON times of the first receive chain 360.

The UE 105 may be configured, for example, for low-power operation, high-power operation, low-positioning-accuracy operation, or for high-positioning-accuracy operation. High-positioning accuracy may be about 1 m accuracy or even sub-1 m accuracy. The configuration of a level of positioning accuracy (and/or other positioning performance characteristics, e.g., acquisition speed, TTFF, etc.) may be explicitly requested by a user of the UE 105 or implicitly requested by the user or another entity, e.g., by configuration of a software application. The positioning performance criteria may vary based on application specific positioning performance requirements. Different software applications (e.g., of the software 332) may have different desired positioning accuracy according to the purpose of the application. Different positioning requests and/or different positioning applications may have different corresponding latencies, desired times to first fix (TTFF), desired positioning accuracies, etc. The processor 310 may measure the satellite signal conditions that may affect positioning performance in order to determine whether the conditions meet the positioning criteria for a specific application. Satellite signal conditions that may affect positioning performance include, for example, the occurrence of cycle slips, the strengths of the satellite positioning signals, and the elevation of the SVs 190-193 whose positioning signals are acquired by the first and second receive chains 360, 370.

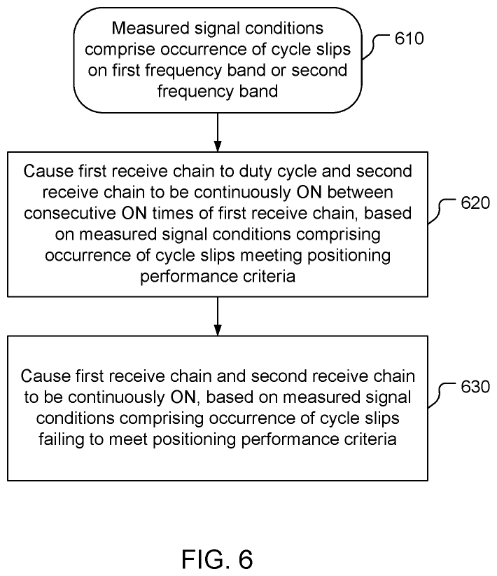

Referring to FIG. 6, the measured signal conditions may comprise the occurrence of cycle slips on the first frequency band and the second frequency band (block 610). A cycle slip refers to a temporary loss of a lock of a tracked carrier signal from one or more of the SVs 190-193. The carrier signal is used to determine the distance between the UE 105 and the SVs very accurately due to the short wavelength of the carrier signal. If a cycle slip occurs, the receive chain 360, 370 loses track of the phase of the carrier signal, which can result in an error in the distance measurement. Cycle slips may occur due to a variety of factors, such as: signal obstruction caused by buildings, trees, terrain, etc.; signal-to-noise or carrier-to-noise ratios (CNR or C/N) caused by multi-path interference, satellite elevation, or attenuation of the signal power due to atmospheric attenuation; and/or internal receiver tracking problems caused by a creeping clock bias reset or incorrect signal processing. Signal blockage may be caused by buildings, bridges, trees, etc. Multi-path interference may occur if the satellite positioning signals do not arrive directly from the SVs 190-193 but are reflected or diffracted, such as off of buildings or walls. Such reflections or diffractions cause the satellite positioning signals to travel paths of different lengths between the SVs 190-193 and the antenna 340 and may result in errors in the distance measurement. Atmospheric conditions (e.g., ionospheric conditions) may affect the strength of the satellite positioning signals through both refraction and diffraction. The satellite positioning signals are altered as they travel through the atmosphere, affecting the speed and direction of the signals. This may cause an apparent delay in transmission of the satellite positioning signals from the SVs 190-193 to the antenna 340, resulting in positioning error. The elevation of the SVs 190-193 may also affect the condition of the satellite positioning signals. As an SV 190-193 moves lower on the horizon, the potential for signal degradation increases. A satellite positioning signal originating from an SV 190-193 near the horizon passes through a larger amount of the ionosphere to reach the antenna 340 than a satellite positioning signal from an SV 190-193 near the zenith. The longer the satellite positioning signal is in the ionosphere as the signal travels to the antenna 340, the greater the signal degradation. Other factors may be considered in combination with the occurrence of cycle slips, e.g., minimum number of acquired SVs, acquisition speeds of the satellite signals, latency, and/or bandwidths of the signals (e.g., with larger bandwidths corresponding to higher time-domain resolution of arrival time measurements for the receiving operation and thus higher accuracy position estimates for the UE 105), etc. Referring again to FIG. 6, the processor 310 causes, based on the measured signal conditions comprising the occurrence of cycle slips meeting the positioning performance criteria (in this example), the first receive chain 360 to duty cycle and the second receive chain 370 to be continuously ON between consecutive ON times of the first receive chain 360 (block 620). The processor 310 causes, based on the measured signal conditions comprising the occurrence of the cycle slips failing to meet the positioning performance criteria (in this example), the first receive chain 360 and the second receive chain 370 to be continuously ON (block 630).

As an example of the above embodiment, a specific application may require a minimum of six acquired SVs and a requirement of cycle slip free carrier phase (measurement) on both the first frequency band and the second frequency band for a minimum of five of the acquired SVs. If the occurrence of cycle slips is detected on one or more of the signals from one of the acquired SVs and the signals from a minimum of five of the other acquired SVs are cycle slip free, the processor 310 may determine that the measured signal conditions still meet the positioning performance criteria for this specific application (assuming the other criteria are also met), may cause the first receive chain 360 to duty cycle, and may cause the second receive chain 370 to be continuously ON between consecutive ON times of the first receive chain 360. The processor 310 may determine, based on the occurrence of cycle slips being detected on two or more of the six acquired SVs, that the measured signal conditions fail to meet the positioning performance criteria for this specific application and may cause the first receive chain 360 to be continuously ON. Should the conditions of the satellite positioning signals recover and the measured signal conditions meet the positioning performance criteria (e.g., SVs are reacquired such that the signals from a minimum of five acquired SVs are cycle slip free), the processor 310 may cause the first receive chain 360 to change modes, e.g., to be duty cycled.

As another example of the above embodiment, the positioning performance requirements of another specific application includes a threshold representing a tolerance for the occurrence of cycle slips, where cycle slip occurrences below the threshold may be an acceptable positioning performance level for this application. The processor 310 may determine, based on the cycle slip occurrences being detected on the acquired SVs is below the threshold, that the measured signal conditions meet the positioning performance criteria for this specific application (assuming the other criteria are also met), may cause the first receive chain 360 to duty cycle, and may cause the second receive chain 370 to be continuously ON between consecutive ON times of the first receive chain 360. The processor 310 may determine, based on the cycle slip occurrences being above the threshold, that the measured signal conditions fail to meet the positioning performance criteria for this specific application and may cause both of the receive chains 360, 370 to be continuously ON. Alternatively, or in addition, the positioning performance criteria may include other parameters to be considered if the detected rate of the cycle slip occurrences are above the threshold. For example, if other measurements (e.g., code phase or other observables) may be relied upon to reconstruct the carrier phase, then the positioning performance criteria may be considered to be met.

If multiple positioning applications are simultaneously executing on the UE 105, and the applications have different positioning performance criteria, the processor 310 may select which criteria to apply to the measured signal conditions, e.g., to prioritize positioning accuracy over power consumption or vice versa. For example, a first application prioritizes positioning accuracy over power savings, while a second application prioritizes power savings over positioning accuracy. If both the first and second applications are invoked on the UE 105, the processor 310 may select the criteria of the first application, with a higher level of requirements for positioning accuracy, to apply to the measured signal conditions.

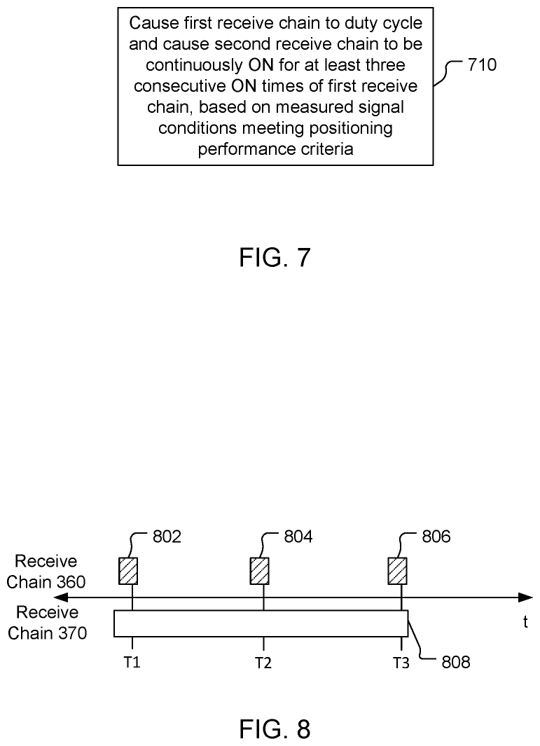

In other embodiments, if the processor 310 determines that the measured signal conditions meet the positioning performance criteria, then the processor 310 may cause the first receive chain 360 and/or the second receive chain 370 to be in a respective mode of operation that maintains measurement observable quality and carrier phase observables while also reducing power consumption. In one embodiment, referring to FIGS. 7 and 8, the processor 310 causes, based on the measured signal conditions meeting the positioning performance criteria, the first receive chain 360 to duty cycle and the second receive chain 370 to be continuously ON for at least three consecutive ON times of the first receive chain 360 (block 710). Causing the second receive chain 370 to be continuously ON over at least three consecutive ON times of the first receive chain 360, versus over at least two consecutive ON times, may allow the processor 310 to obtain additional measurements, possibly improving maintenance of observable quality and carrier phase observables while still reducing power consumption. Segments 802, 804, and 806 in FIG. 8 represent times during which the first receive chain 360 is ON. Segment 808 represents times during which the second receive chain 370 is continuously ON for the three times, represented by the segments 802, 804, and 806. The processor 310, possibly in combination with the memory 330, may comprise means for causing the second receive chain 370 to be continuously ON for at least three consecutive ON times of the first receive chain 360.

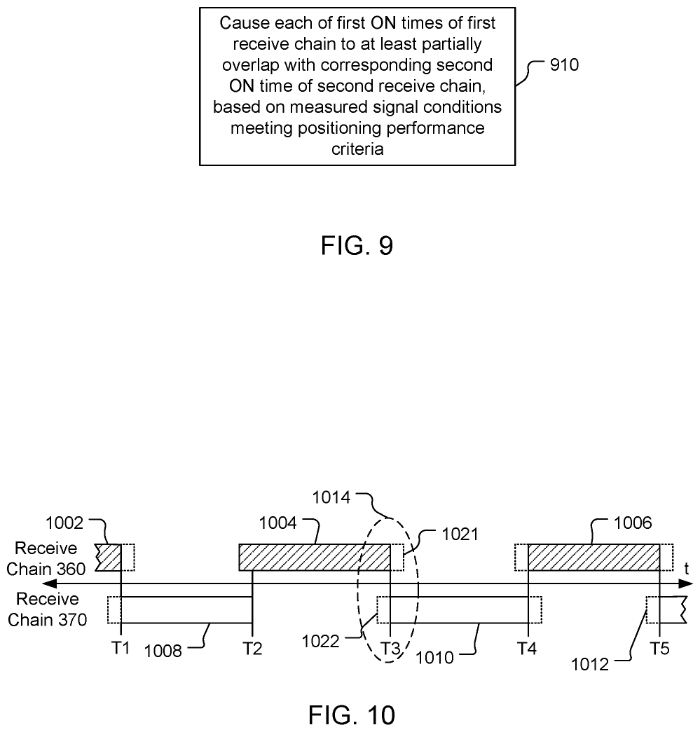

In another embodiment, referring to FIGS. 9-10, the processor 310 causes, based on the processor 310 determining that the measured signal conditions meet the positioning performance criteria, each of the first ON times of the first receive chain 360 to at least partially overlap with corresponding second ON times of the second receive chain 370 (block 910). The processor 310, possibly in combination with the memory 330, in combination with the receive chain 370 may comprise means for causing each of the first ON times of the first receive chain 360 to at least partially overlap with corresponding second ON times of the second receive chain 370. As illustrated in FIG. 10, the first receive chain 360 is duty cycled, with segments 1002, 1004, and 1006 representing times during which the first receive chain 360 is ON. The second receive chain 370 is also duty cycled, with segments 1008, 1010, and 1012 representing times during which the second receive chain 370 is ON. The ON times of the first receive chain 360 (represented by segments 1004 and 1006) and the ON times of the second receive chain 370 (represented by segments 1008 and 1010) alternate, such that if the first receive chain 360 is ON, the second receive chain 370 is OFF, and vice versa (while not including optional portions of ON segments that overlap). In combination, there are no gaps in the receipt of measurement observables and carrier phase observables from the satellite positioning signals throughout the time period from time instance T1 to time instance T5. Thus, at any time between time instance T1 and time instance T5, observables are measured by at least one of the first receive chain 360 and the second receive chain 370.

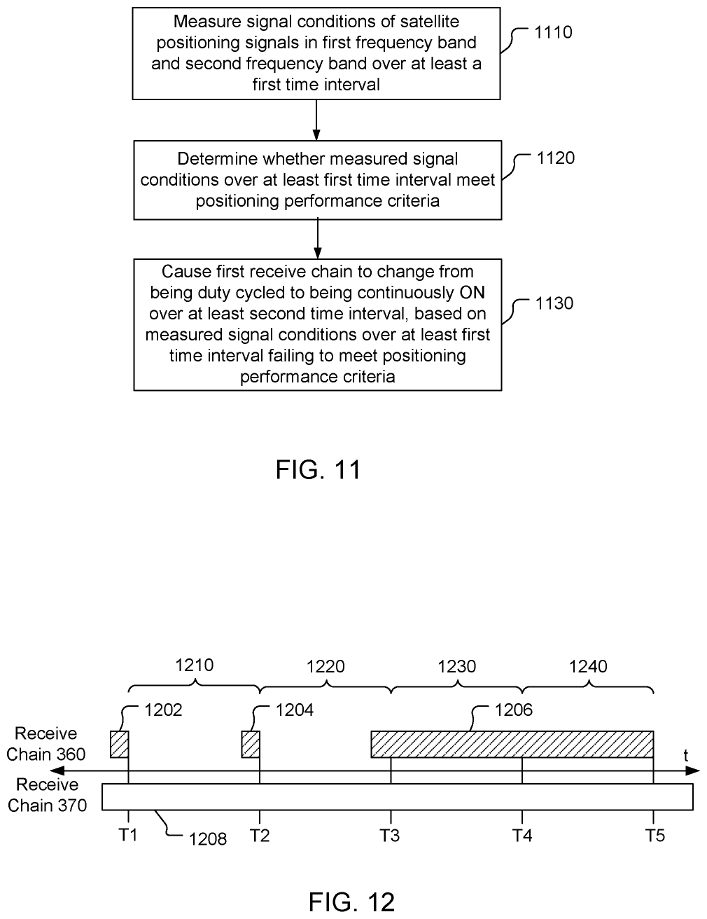

In yet another embodiment, referring to FIG. 11, the processor 310 measures the signal conditions of the satellite positioning signals in a first frequency band and a second frequency band over at least a first time interval (block 1110). The processor 310 determines whether the measured signal conditions over at least the first time interval meet the positioning performance criteria (block 1120). The processor 310 causes, based on the measured signal conditions over at least the first time interval failing to meet the positioning performance criteria, the first receive chain 360 to change from being duty cycled to being continuously ON over at least a second time interval (block 1130). The processor 310, possibly in combination with the memory 330, in combination with the first receive chain 360, may comprise means for measuring the signal conditions, means for determining whether the measured signal conditions meet the positioning performance criteria, and means for causing the first receive chain 360 to change from being duty cycled to being continuously ON over at least the second time interval. Referring again to FIG. 10, the first receive chain 360 and the second receive chain 370 are duty cycled, where the ON times of the first receive chain 360 and the second receive chain 370 alternate. The processor 310 causes each of the first ON times of the first receive chain 360 to at least partially overlap with a corresponding second ON time of the second receive chain 370. For example, an overlap 1014 is illustrated in FIG. 10 near time instance T3 due to one or both of optional segment portions 1021, 1022. Similar overlaps are illustrated near time instances T1, T2, T4, and T5. The overlaps ensure that the first and second receive chains 360, 370 are both ON for some amount of time to enable the reconstruction of the carrier phase. For example, the duration of the overlap may be set to a time duration to enable reception of a valid fractional portion of the full phase cycle on the first and second frequency bands, thus allowing for the reconstruction of the carrier phase. Included in the time duration of the overlap is any settling time for the satellite signal to stabilize upon changing the second receive chain 370 to ON. Although FIG. 10 illustrates overlaps between ON times of the two receiver chains 360, 370 only near the beginnings and the ends of their respective segments, overlap of ON times may occur at other times during the segments, e.g., as discussed below with respect to FIG. 16.

In another embodiment, the determination by the processor 310 of whether the measure signal conditions meet the positioning performance criteria may occur at an end of a time interval. For example, the determination of whether the measured signal conditions over at least the first time interval met the positioning performance criteria may occur at the end of a time interval. FIG. 12 illustrates example time intervals 1210, 1220, 1230, and 1240, with determination points occurring at time instances T1, T2, T3, T4, and T5. The processor 310 causes the first receive chain 360 to be duty cycled (represented by segments 1202 and 1204) and causes the second receive chain 370 to be continuously ON (represented by segment 1208) during time intervals 1210 and 1220. The processor 310 further measures the signal conditions on the first and second frequency bands over at least the time interval 1220. Signal conditions may also be measured over at least the time interval 1210. At a determination point, e.g., the end of time interval 1220 at time instance T3, in response to determining that the measured signal conditions over at least the time interval 1220 fail to meet the positioning performance criteria, the processor 310 causes the operation of one or more of the receive chains 360, 370 to change. For example, the processor 310 may cause the first receive chain 360 to change from being duty cycled to being continuously ON (represented by segment 1206) over at least the time interval 1230.

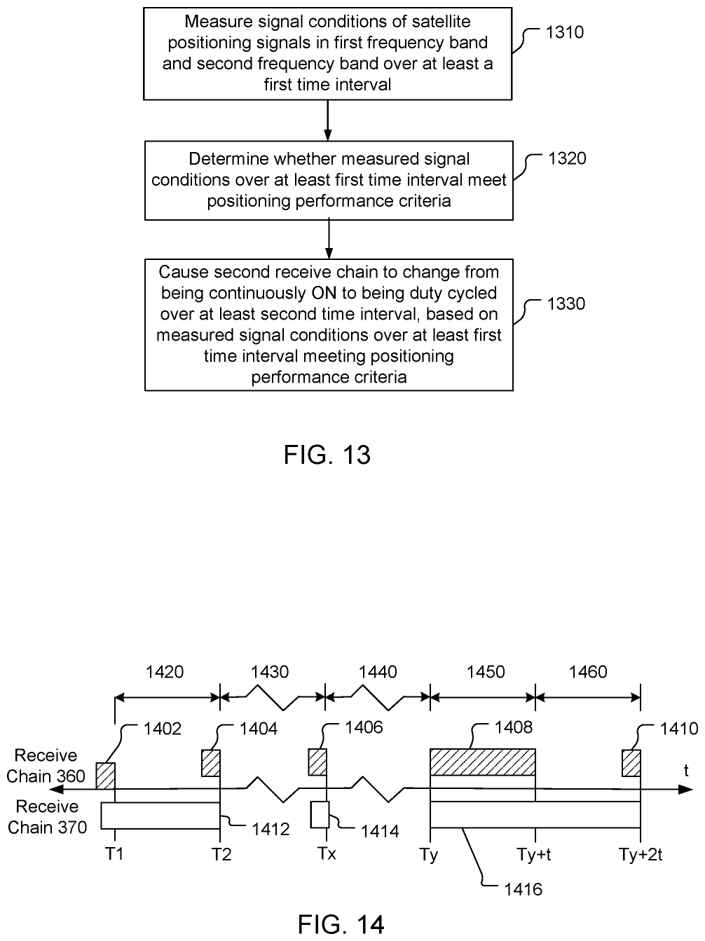

In another embodiment, the processor 310 determines whether to change the operation of the second receive chain 370. Referring to FIGS. 13 and 14, the processor 310 measures the signal conditions of the satellite positioning signals in the first and second frequency bands over at least one time interval (block 1310). The processor 310, possibly in combination with the memory 330, in combination with the receive chains 360, 370 may comprise means for measuring signal conditions on the first and second frequency bands. The processor 310 determines whether the measured signal conditions over at least the first time interval meet the positioning performance criteria (block 1320). The processor 310 causes, based on the measured signal conditions over at least the first time interval meeting the positioning performance criteria, the second receive chain 370 to change from being continuously ON to being duty cycled over at least a second time interval (block 1330). The processor 310, possibly in combination with the memory 330, in combination with the second receive chain 370 may comprise means for determining whether the signal conditions over at least the first time interval meet the positioning performance criteria and means for causing the second receive chain 370 to change from being continuously ON to being duty cycled over at least the second time interval. For example, the determination can occur at the end of a time interval. FIG. 14 illustrates time interval 1420, one or more time intervals 1430, one or more time intervals 1440, time interval 1450, and time interval 1460. The determination points occur at time instances T1, T2, Tx Ty, Ty+t, and Ty+2t. The second receive chain 370 is continuously ON (represented by segment 1412) between at least two consecutive ON times of the first receive chain 360 (represented by segments 1402 and 1404). The processor 310 measures signal conditions of the satellite positioning signals on the first and second frequency bands at least during the time interval 1420. At a determination point such as time instance T2, in response to determining that the measured signal conditions meet the positioning performance criteria, the processor 310 changes the second receive chain 370 from being continuously ON to being duty cycled over at least time interview 1530 (represented by segment 1414).

In another embodiment, referring again to FIG. 14, after the processor 310 causes the second receive chain 370 to change from being continuously ON to being duty cycled at time instance T2 (represented by segment 1414), the processor 310 continues to measure signal conditions during time intervals 1430 and 1440. Based on the measured signal conditions, at time instance Ty, the processor 310 determines that the measured signal conditions over the time intervals 1430 and 1440 fail to meet the positioning performance criteria and causes the second receive chain 370 to change from being duty cycled to being continuously ON (represented by segment 1416).

In another embodiment, after the processor 310 causes the first receive chain 360 to change from being duty cycled (represented by segments 1402, 1404, and 1406) to being continuously ON at time instance Ty (represented by segment 1408), the processor 310 continues to measure signal conditions of the satellite positioning signals during the time interval 1450. At time instance Ty+t, the processor 310 causes the first receive chain 360 to change from being continuously ON to being duty cycled (represented by segment 1410), based on the processor 310 determining that the measured signal conditions over time interval 1450 meets the positioning performance criteria. The processor 310, possibly in combination with the memory 330, in combination with the first receive chain 360 may comprise means for changing the first receive chain 360 from being continuously ON to being duty cycled.

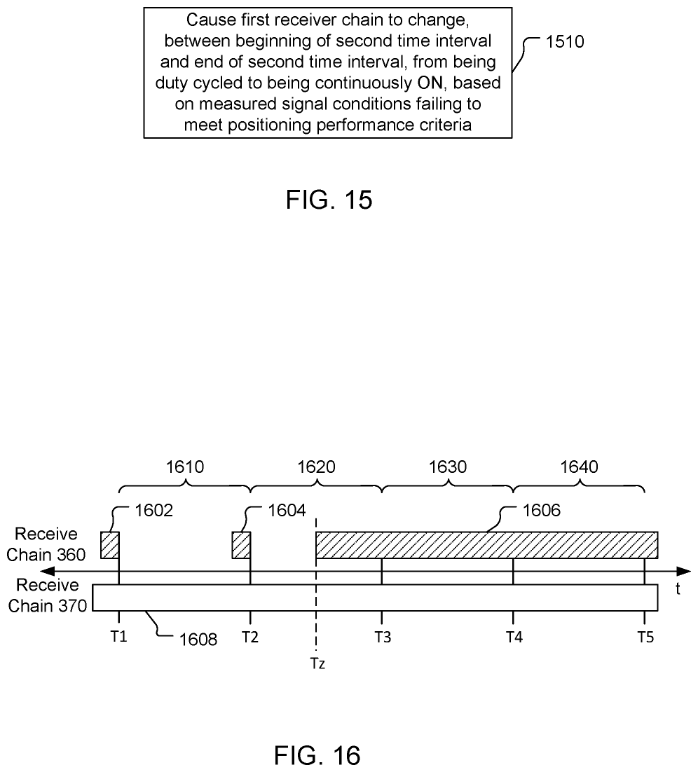

In another embodiment, the determination of whether the measured signal conditions meet the positioning performance criteria occurs at a time between a beginning and an end of a time interval between scheduled determinations of the position of the UE 105. Referring to FIGS. 15 and 16, the processor 310 causes the first receive chain 360 to change, between a beginning of a time interval and an end of the time interval, from being duty cycled to being continuously ON based on the processor 310 determining that the measured signal conditions fail to meet the positioning performance criteria (block 1510). FIG. 16 illustrates time intervals 1610, 1620, 1630, and 1640, with an example determination point occurring at time instance Tz, between a beginning (time instance T2) and an end (time instance T3) of the time interval 1620. Similar determination points may also occur between the beginning and end times of any of the time intervals 1610, 1630, and 1640. For example, at time instance T1, the first receive chain 360 is duty cycled (represented by segments 1602 and 1604), and the second receive chain 370 is continuously ON (represented by segment 1608). The processor 310 measures signal conditions of the satellite positioning signals in the first and second frequency bands over the time interval 1610 and part of the time interval 1620 from time instance T2 to time instance Tz, with Tz being a time instance between a beginning and an end of the time interval 1620. The processor 310 determines whether the measured signal conditions meet the positioning performance criteria. Based on the measured signal conditions failing to meet the positioning performance criteria, at time instance Tz, the processor 310 causes the first receive chain 360 to change from being duty cycled to being continuously ON (represented by segment 1606). The processor 310, possibly in combination with the memory 330, in combination with the first receive chain 360 may comprise means for causing the first receive change 360 to change, between a beginning of a time interval and an end of the time interval, from being duty cycled to being continuously ON.

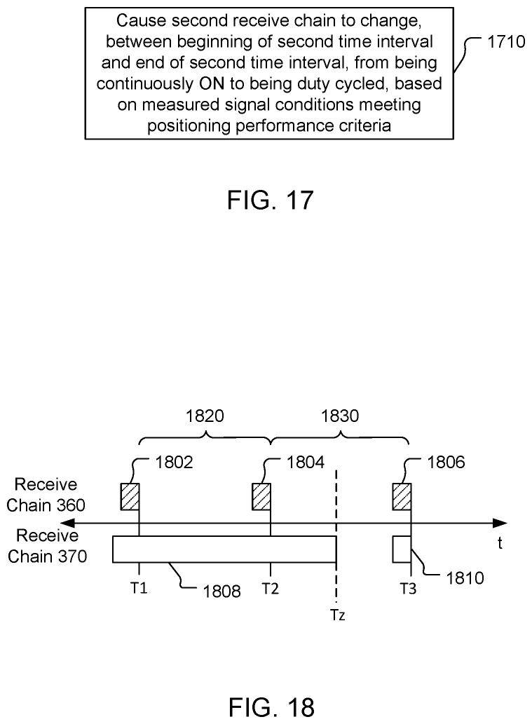

In another embodiment, the processor 310 causes the second receive chain 370 to change, between a beginning and an end of a time interval between scheduled determinations of the position of the UE 105, from being continuously ON to being duty cycled. For example, referring to FIGS. 17 and 18, the processor 310 causes the second receive chain 370 to change, between a beginning of a time interval and an end of the time interval, from being continuously ON to being duty cycled, based on the processor 310 determining that the measured signal conditions meet the positioning performance criteria (block 1710). FIG. 18 illustrates time intervals 1820 and 1830, with an example determination point occurring at time instance Tz between the beginning (time instance T2) and the end (time instance T3) of the time interval 1830. A similar determination point may also occur between the beginning and end times of the time interval 1820. For example, at time instance T1, the first receive chain 360 is duty cycled (represented by segments 1820, 1804, and 1806), and the second receive chain 370 is continuously ON (represented by segment 1808). The processor 310 measures signal conditions of the satellite positioning signals in the first and second frequency bands over the time interval 1820, and part of the time interval 1830 on the second frequency band (represented by segment 1810), from time instance T2 to time instance Tz. At time instance Tz, the processor 310 causes the second receive chain 370 to change from being continuously ON to being duty cycled. The processor 310, in combination with the memory 330, in combination with the second receive chain 370 may comprise means for causing the second receive chain 370 to change, between a beginning of a time interval and an end of the time interval, from being continuously to being duty cycled.

### IMPLEMENTATION EXAMPLES

Implementation examples are provided in the following numbered clauses.
Clause 1. A user equipment, comprising:
a first receive chain configured to receive and output satellite positioning signals in a first frequency band;
a second receive chain configured to receive and output satellite positioning signals in a second frequency band;
one or more memories; and
one or more processors communicatively coupled to the first receive chain, the second receive chain, and the one or more memories, the one or more processors being configured to:
measure signal conditions of the satellite positioning signals in the first frequency band and the second frequency band;
determine whether the measured signal conditions meet positioning performance criteria; and
cause, based on the measured signal conditions meeting the positioning performance criteria, the first receive chain to duty cycle between a first state and a second state and the second receive chain to be in the first state during the duty cycling of the first receive chain.
Clause 2. The user equipment of clause 1, wherein the first state is ON and the second state is OFF.
Clause 3. The user equipment of clause 2, wherein the one or more processors are further configured to: cause, based on the measured signal conditions meeting the positioning performance criteria, the first receive chain to duty cycle and the second receive chain to be continuously ON between at least two consecutive ON times of the first receive chain.
Clause 4. The user equipment of clause 2, wherein the one or more processors are further configured to: cause, based on the measured signal conditions failing to meet the positioning performance criteria, the first receive chain and the second receive chain to be continuously ON.
Clause 5. The user equipment of clause 2, wherein the measured signal conditions comprise occurrence of cycle slips on the first frequency band or the second frequency band, wherein the one or more processors are further configured to:
cause, based on the measured signal conditions comprising the occurrence of the cycle slips meet the positioning performance criteria, the first receive chain to duty cycle and the second receive chain to be continuously ON between consecutive ON times of the first receive chain; and
cause, based on the measured signal conditions comprising the occurrence of the cycle slips fail to meet the positioning performance criteria, the first receive chain and the second receive chain to be continuously ON.
Clause 6. The user equipment of clause 5, wherein the measured signal conditions comprise a combination of the occurrence of the cycle slips, strengths of the satellite positioning signals received on the first frequency band or the second frequency band, and elevations of satellite vehicles acquired using the first receive chain or the second receive chain, wherein the one or more processors are configured to:
cause, based on the measured signal conditions comprising the combination meet the positioning performance criteria, the first receive chain to duty cycle and the second receive chain to be continuously ON between consecutive ON times of the first receive chain; and
cause, based on the measured signal conditions comprising the combination fail to meet the positioning performance criteria, the first receive chain and the second receive chain to be continuously ON.
Clause 7. The user equipment of clause 2, wherein the one or more processors are configured to: cause, based on the measured signal conditions meeting the positioning performance criteria, the first receive chain to duty cycle and the second receive chain to be ON for at least three consecutive ON times of the first receive chain.
Clause 8. The user equipment clause 2, wherein the one or more processors are configured to: cause, based on the measured signal conditions meeting the positioning performance criteria, each of the first ON times of the first receive chain to at least partially overlap with a corresponding second ON time of the second receive chain.
Clause 9. The user equipment of clause 2, wherein the one or more processors are configured to:
measure signal conditions of the satellite positioning signals in the first frequency band and the second frequency band over at least a first time interval;
determine whether the measured signal conditions over at least the first time interval meet the positioning performance criteria; and
cause, based on the measured signal conditions over the at least first time interval failing to meet the positioning performance criteria, the first receive chain to change from being duty cycled to being continuously ON over at least a second time interval.
Clause 10. The user equipment clause 9, wherein the one or more processors are configured to cause the first receive chain to change, between a beginning of the second time interval and an end of the second time interval, from being duty cycled to being continuously ON.
Clause 11. The user equipment of clause 2, wherein the one or more processors are configured to:
measure signal conditions of the satellite positioning signals in the first frequency band and the second frequency band over at least a first time interval;
determine whether the measured signal conditions over at least the first time interval meet the positioning performance criteria; and
cause, based on the measured signal conditions over the at least first time interval meeting the positioning performance criteria, the second receive chain to change from being continuously ON to being duty cycled over at least a second time interval.
Clause 12. The user equipment clause 11, wherein the one or more processors are configured to cause the second receive chain to change, between a beginning of the second time interval and an end of the second time interval, from being continuously ON to being duty cycled.
Clause 13. The user equipment of clause 2 or 3, wherein the one or more processors are further configured to: cause, based on the measured signal conditions failing to meet the positioning performance criteria, the first receive chain and the second receive chain to be continuously ON.
Clause 14. The user equipment clause 2, 3, or 4, wherein the one or more processors are configured to: cause, based on the measured signal conditions meeting the positioning performance criteria, each of the first ON times of the first receive chain to at least partially overlap with a corresponding second ON time of the second receive chain.
Clause 15. The user equipment of clause 2 or 9, wherein the one or more processors are configured to:
measure signal conditions of the satellite positioning signals in the first frequency band and the second frequency band over at least a first time interval;
determine whether the measured signal conditions over at least the first time interval meet the positioning performance criteria; and
cause, based on the measured signal conditions over the at least first time interval meeting the positioning performance criteria, the second receive chain to change from being continuously ON to being duty cycled over at least a second time interval. Clause 16. A satellite signal processing method, comprising:
measuring signal conditions of satellite positioning signals received using a first receive chain configured to receive and output satellite positioning signals in a first frequency band and a second receive chain configured to receive and output satellite positioning signals in a second frequency band;
determining whether the measured signal conditions meet positioning performance criteria; and
causing, based on the measured signal conditions meeting the positioning performance criteria, the first receive chain to duty cycle between a first state and a second state and the second receive chain to be in the first state during the duty cycling of the first receive chain.
Clause 17. The satellite signal processing method of clause 16, wherein the first state is ON and the second state is OFF.
Clause 18. The satellite signal processing method of clause 17, further comprising: causing, based on the measured signal conditions meeting the positioning performance criteria, the first receive chain to duty cycle and the second receive chain to be continuously ON between at least two consecutive ON times of the first receive chain.
Clause 19. The satellite signal processing method of clause 17, further comprising: causing, based on the measured signal conditions failing to meet the positioning performance criteria, the first receive chain and the second receive chain to be continuously ON.
Clause 20. The satellite signal processing method of clause 17, wherein the measured signal conditions comprise occurrence of cycle slips on the first frequency band or the second frequency band, wherein the method further comprises:
causing, based on the measured signal conditions comprising the occurrence of the cycle slips meet the positioning performance criteria, the first receive chain to duty cycle and the second receive chain to be continuously ON between consecutive ON times of the first receive chain; and
causing, based on the measured signal conditions comprising the occurrence of the cycle slips fail to meet the positioning performance criteria, the first receive chain and the second receive chain to be continuously ON.
Clause 21. The satellite signal processing method of clause 20, wherein the measured signal conditions comprise a combination of the occurrence of the cycle slips, strengths of the satellite positioning signals received on the first frequency band or the second frequency band and elevations of satellite vehicles acquired using the first receive chain or the second receive chain, wherein the method comprises:
causing, based on the measured signal conditions comprising the combination meet the positioning performance criteria, the first receive chain to duty cycle and the second receive chain to be continuously ON between consecutive ON times of the first receive chain; and
causing, based on the measured signal conditions comprising the combination fail to meet the positioning performance criteria, the first receive chain and the second receive chain to be continuously ON.
Clause 22. The satellite signal processing method of clause 17, further comprising: causing, based on the measured signal conditions meet the positioning performance criteria, the first receive chain to duty cycle and the second receive chain to be continuously ON for at least three consecutive ON times of the first receive chain.
Clause 23. The satellite signal processing method of clause 17, further comprising: causing, based on the measured signal conditions meeting the positioning performance criteria, each of the first ON times of the first receive chain to at least partially overlap with a corresponding second ON time of the second receive chain.
Clause 24. The satellite signal processing method of clause 17, further comprising:
measuring signal conditions of the satellite positioning signals in the first frequency band and the second frequency band over at least a first time interval;
determining whether the measured signal conditions over at least the first time interval meet the positioning performance criteria; and
causing, based on the measured signal conditions over the at least first time interval failing to meet the positioning performance criteria, the first receive chain to change from being duty cycled to being continuously ON over at least a second time interval.
Clause 25. The satellite signal processing method of clause 24, wherein causing the first receive chain to change comprises: causing the first receive chain to change, between a beginning of the second time interval and an end of the second time interval, from being duty cycled to being continuously ON.
Clause 26. The satellite signal processing method of clause 17, further comprising:
measuring signal conditions of the satellite positioning signals in the first frequency band and the second frequency band over at least a first time interval;
determining whether the measured signal conditions over at least the first time interval meet the positioning performance criteria; and
causing, based on the measured signal conditions over the at least first time interval meeting the positioning performance criteria, the second receive chain to change from being continuously ON to being duty cycled over at least a second time interval.
Clause 27. The satellite signal processing method of clause 26, wherein causing the second receive chain to change comprises: causing the second receive chain to change, between a beginning of the second time interval and an end of the second time interval, from being continuously ON to being duty cycled.
Clause 28. The satellite signal processing method of clause 17 or 18, further comprising: causing, based on the measured signal conditions failing to meet the positioning performance criteria, the first receive chain and the second receive chain to be continuously ON.
Clause 29. The satellite signal processing method of clause 17, 18, or 19, further comprising: causing, based on the measured signal conditions meeting the positioning performance criteria, each of the first ON times of the first receive chain to at least partially overlap with a corresponding second ON time of the second receive chain.
Clause 30. The satellite signal processing method of clause 17 or 24, further comprising:
measuring signal conditions of the satellite positioning signals in the first frequency band and the second frequency band over at least a first time interval;
determining whether the measured signal conditions over at least the first time interval meet the positioning performance criteria; and
causing, based on the measured signal conditions over the at least first time interval meeting the positioning performance criteria, the second receive chain to change from being continuously ON to being duty cycled over at least a second time interval. Clause 31. A user equipment, comprising:
means for measuring signal conditions of satellite positioning signals received using a first receive chain configured to receive and output satellite positioning signals in a first frequency band and a second receive chain configured to receive and output satellite positioning signals in a second frequency band;
means for determining whether the measured signal conditions meet positioning performance criteria; and
means for, causing, based on the measured signal conditions meeting the positioning performance criteria, the first receive chain to duty cycle between a first state and a second state and the second receive chain to be in the first state during the duty cycling of the first receive chain.
Clause 32. The user equipment of clause 31, wherein the first state is ON and the second state is OFF.
Clause 33. The user equipment of clause 32, further comprising: means for causing, based on the measured signal conditions meeting the positioning performance criteria, the first receive chain to duty cycle and the second receive chain to be continuously ON between at least two consecutive ON times of the first receive chain.
Clause 34. The user equipment of clause 32, further comprising: means for, causing, based on the measured signal conditions failing to meet the positioning performance criteria, the first receive chain and the second receive chain to be continuously ON.
Clause 35. The user equipment of clause 32, wherein the measured signal conditions comprise occurrence of cycle slips on the first frequency band or the second frequency band, wherein the user equipment further comprises:
means for, causing, based on the measured signal conditions comprising the occurrence of the cycle slips meet the positioning performance criteria, the first receive chain to duty cycle and the second receive chain to be continuously ON between consecutive ON times of the first receive chain; and
means for, causing, based on the measured signal conditions comprising the occurrence of the cycle slips fail to meet the positioning performance criteria, the first receive chain and the second receive chain to be continuously ON.
Clause 36. The user equipment of clause 35, wherein the measured signal conditions comprise a combination of the occurrence of the cycle slips, strengths of the satellite positioning signals received on the first frequency band or the second frequency band and elevations of satellite vehicles acquired using the first receive chain or the second receive chain, wherein the user equipment comprises:
means for causing, based on the measured signal conditions comprising the combination meet the positioning performance criteria, the first receive chain to duty cycle and the second receive chain to be continuously ON between consecutive ON times of the first receive chain; and
means for, causing, based on the measured signal conditions comprising the combination fail to meet the positioning performance criteria, the first receive chain and the second receive chain to be continuously ON.
Clause 37. The user equipment of clause 32, further comprising: means for causing, based on the measured signal conditions meeting the positioning performance criteria, the first receive chain to duty cycle and the second receive chain to be continuously ON for at least three consecutive ON times of the first receive chain.
Clause 38. The user equipment of clause 32, further comprising: means for, causing, based on the measured signal conditions meeting the positioning performance criteria, each of the first ON times of the first receive chain to at least partially overlap with a corresponding second ON time of the second receive chain.
Clause 39. The user equipment of clause 32, further comprising:
means for measuring signal conditions of the satellite positioning signals in the first frequency band and the second frequency band over at least a first time interval;
means for determining whether the measured signal conditions over at least the first time interval meet the positioning performance criteria; and
means for causing, based on the measured signal conditions over the at least first time interval failing to meet the positioning performance criteria, the first receive chain to change from being duty cycled to being continuously ON over at least a second time interval.
Clause 40. The user equipment of clause 39, wherein the means for causing the first receive chain to change comprises: means for causing the first receive chain to change, between a beginning of the second time interval and an end of the second time interval, from being duty cycled to being continuously ON.
Clause 41. The user equipment of clause 32, further comprising:
means for measuring signal conditions of the satellite positioning signals in the first frequency band and the second frequency band over at least a first time interval;
means for determining whether the measured signal conditions over at least the first time interval meet the positioning performance criteria; and
means for causing, based on the measured signal conditions over the at least first time interval meeting the positioning performance criteria, the second receive chain to change from being continuously ON to being duty cycled over at least a second time interval.
Clause 42. The user equipment of clause 41, wherein the means for causing the second receive chain to change comprises: means for causing the second receive chain to change, between a beginning of the second time interval and an end of the second time interval, from being continuously ON to being duty cycled.
Clause 43. The user equipment of clause 32 or 33, further comprising: means for, causing, based on the measured signal conditions failing to meet the positioning performance criteria, the first receive chain and the second receive chain to be continuously ON.
Clause 44. The user equipment of clause 32, 33, or 34, further comprising: means for, causing, based on the measured signal conditions meeting the positioning performance criteria, each of the first ON times of the first receive chain to at least partially overlap with a corresponding second ON time of the second receive chain.
Clause 45. The user equipment of clause 32 or 30, further comprising:
means for measuring signal conditions of the satellite positioning signals in the first frequency band and the second frequency band over at least a first time interval;
means for determining whether the measured signal conditions over at least the first time interval meet the positioning performance criteria; and
means for causing, based on the measured signal conditions over the at least first time interval meeting the positioning performance criteria, the second receive chain to change from being continuously ON to being duty cycled over at least a second time interval.
Clause 46. A non-transitory, processor readable storage medium comprising processor-readable instructions to cause one or more processors of a user equipment to:
measure signal conditions of satellite positioning signals received using a first receive chain configured to receive and output satellite positioning signals in a first frequency band and a second receive chain configured to receive and output satellite positioning signals in a second frequency band;
determine whether the measured signal conditions meet positioning performance criteria; and
cause, based on the measured signal conditions meeting the positioning performance criteria, the first receive chain to duty cycle between a first state and a second state and the second receive chain to be in the first state during the duty cycling of the first receive chain.
Clause 47. The medium of clause 46, wherein the first state is ON and the second state is OFF.
Clause 48. The medium of clause 47, further comprising: cause, based on the measured signal conditions meeting the positioning performance criteria, the first receive chain to duty cycle and the second receive chain to be continuously ON between at least two consecutive ON times of the first receive chain.
Clause 49. The medium of clause 47, wherein the one or more processors are further configured to: cause, based on the measured signal conditions failing to meet the positioning performance criteria, the first receive chain and the second receive chain to be continuously ON.
Clause 50. The medium of clause 47, wherein the measured signal conditions comprise occurrence of cycle slips on the first frequency band or the second frequency band, wherein the one or more processors are further configured to:
cause, based on the measured signal conditions comprising the occurrence of the cycle slips meeting the positioning performance criteria, the first receive chain to duty cycle and the second receive chain to be continuously ON between consecutive ON times of the first receive chain; and
cause, based on the measured signal conditions comprising the occurrence of the cycle slips failing to meet the positioning performance criteria, the first receive chain and the second receive chain to be continuously ON.
Clause 51. The medium of clause 50, wherein the measured signal conditions comprise a combination of the occurrence of the cycle slips, strengths of the satellite positioning signals received on the first frequency band or the second frequency band and elevations of satellite vehicles acquired using the first receive chain or the second receive chain, wherein the one or more processors are configured to:
cause, based on the measured signal conditions comprising the combination meeting the positioning performance criteria, the first receive chain to duty cycle and the second receive chain to be continuously ON between consecutive ON times of the first receive chain; and
cause, based on the measured signal conditions comprising the combination failing to meet the positioning performance criteria, the first receive chain and the second receive chain to be continuously ON.
Clause 52. The medium of clause 47, wherein the one or more processors are further caused to: cause, based on the measured signal conditions meeting the positioning performance criteria, the first receive chain to duty cycle and the second receive chain to be continuously ON for at least three consecutive ON times of the first receive chain.
Clause 53. The medium of clause 47, wherein the one or more processors are further caused to: cause, based on the measured signal conditions meeting the positioning performance criteria, each of the first ON times of the first receive chain to at least partially overlap with a corresponding second ON time of the second receive chain.
Clause 54. The medium of clause 47, wherein the one or more processors are further caused to:
measure signal conditions of the satellite positioning signals in the first frequency band and the second frequency band over at least a first time interval;
determine whether the measured signal conditions over at least the first time interval meet the positioning performance criteria; and
cause, based on the measured signal conditions over the at least first time interval failing to meet the positioning performance criteria, the first receive chain from being duty cycled to being continuously ON over at least a second time interval.
Clause 55. The medium of clause 54, wherein in causing the first receive chain to change, the one or more processors are further caused to: cause the first receive chain to change, between a beginning of the second time interval and an end of the second time interval, the first receive chain to be continuously ON.
Clause 56. The medium of clause 47, wherein the one or more processors are further caused to:
measure signal conditions of the satellite positioning signals in the first frequency band and the second frequency band over at least a first time interval;
determine whether the measured signal conditions over at least the first time interval meet the positioning performance criteria; and
cause, based on the measured signal conditions over the at least first time interval meeting the positioning performance criteria, the second receive chain to change from being continuously ON between the at least two consecutive ON times of the first receive chain to being duty cycled over at least a second time interval.
Clause 57. The medium of clause 56, wherein in causing the second receive cycle to change, the one or more processors are further caused to: cause the second receive chain to change, between a beginning of the second time interval and an end of the second time interval, from being continuously ON to being duty cycled.
Clause 58. The medium of clause 47 or 48, wherein the one or more processors are further configured to: cause, based on the measured signal conditions failing to meet the positioning performance criteria, the first receive chain and the second receive chain to be continuously ON.
Clause 59. The medium of clause 47, 48, or 49, wherein the one or more processors are further caused to: cause, based on the measured signal conditions meeting the positioning performance criteria, each of the first ON times of the first receive chain to at least partially overlap with a corresponding second ON time of the second receive chain.
Clause 60. The medium of clause 47 or 54, wherein the one or more processors are further caused to:
measure signal conditions of the satellite positioning signals in the first frequency band and the second frequency band over at least a first time interval;
determine whether the measured signal conditions over at least the first time interval meet the positioning performance criteria; and
cause, based on the measured signal conditions over the at least first time interval meeting the positioning performance criteria, the second receive chain to change from being continuously ON between the at least two consecutive ON times of the first receive chain to being duty cycled over at least a second time interval.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Even if referred to in the singular, including in the claims, a device (e.g., a processor, a memory, transceiver, network entity, etc.) may include one or more of such devices (e.g., one or more processors, one or more memories, one or more transceivers, one or more network entities, etc.). The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A user equipment, comprising:
a first receive chain configured to receive and output satellite positioning signals in a first frequency band;
a second receive chain configured to receive and output satellite positioning signals in a second frequency band;
one or more memories; and
one or more processors communicatively coupled to the first receive chain, the second receive chain, and the one or more memories, the one or more processors being configured to:
measure signal conditions of the satellite positioning signals in the first frequency band and the second frequency band;
determine whether the measured signal conditions meet positioning performance criteria; and
cause, based on the measured signal conditions meeting the positioning performance criteria, the first receive chain to duty cycle between a first state and a second state and the second receive chain to be in the first state during the duty cycling of the first receive chain.

2. The user equipment of claim 1, wherein the first state is ON and the second state is OFF.

3. The user equipment of claim 2, wherein the one or more processors are further configured to:
cause, based on the measured signal conditions meeting the positioning performance criteria, the first receive chain to duty cycle and the second receive chain to be continuously ON between at least two consecutive ON times of the first receive chain.

4. The user equipment of claim 2, wherein the one or more processors are further configured to:
cause, based on the measured signal conditions failing to meet the positioning performance criteria, the first receive chain and the second receive chain to be continuously ON.

5. The user equipment of claim 2, wherein the measured signal conditions comprise occurrence of cycle slips on the first frequency band or the second frequency band, wherein the one or more processors are further configured to:
cause, based on the measured signal conditions comprising the occurrence of the cycle slips meet the positioning performance criteria, the first receive chain to duty cycle and the second receive chain to be continuously ON between consecutive ON times of the first receive chain; and
cause, based on the measured signal conditions comprising the occurrence of the cycle slips fail to meet the positioning performance criteria, the first receive chain and the second receive chain to be continuously ON.

6. The user equipment of claim 5, wherein the measured signal conditions comprise a combination of the occurrence of the cycle slips, strengths of the satellite positioning signals received on the first frequency band or the second frequency band, and elevations of satellite vehicles acquired using the first receive chain or the second receive chain, wherein the one or more processors are configured to:
cause, based on the measured signal conditions comprising the combination meet the positioning performance criteria, the first receive chain to duty cycle and the second receive chain to be continuously ON between consecutive ON times of the first receive chain; and
cause, based on the measured signal conditions comprising the combination fail to meet the positioning performance criteria, the first receive chain and the second receive chain to be continuously ON.

7. The user equipment of claim 2, wherein the one or more processors are configured to: cause, based on the measured signal conditions meeting the positioning performance criteria, the first receive chain to duty cycle and the second receive chain to be ON for at least three consecutive ON times of the first receive chain.

8. The user equipment claim 2, wherein the one or more processors are configured to: cause, based on the measured signal conditions meeting the positioning performance criteria, each of the first ON times of the first receive chain to at least partially overlap with a corresponding second ON time of the second receive chain.

9. The user equipment of claim 2, wherein the one or more processors are configured to:
measure signal conditions of the satellite positioning signals in the first frequency band and the second frequency band over at least a first time interval;
determine whether the measured signal conditions over at least the first time interval meet the positioning performance criteria; and
cause, based on the measured signal conditions over the at least first time interval failing to meet the positioning performance criteria, the first receive chain to change from being duty cycled to being continuously ON over at least a second time interval.

10. The user equipment claim 9, wherein the one or more processors are configured to cause the first receive chain to change, between a beginning of the second time interval and an end of the second time interval, from being duty cycled to being continuously ON.

11. The user equipment of claim 2, wherein the one or more processors are configured to:
measure signal conditions of the satellite positioning signals in the first frequency band and the second frequency band over at least a first time interval;
determine whether the measured signal conditions over at least the first time interval meet the positioning performance criteria; and
cause, based on the measured signal conditions over the at least first time interval meeting the positioning performance criteria, the second receive chain to change from being continuously ON to being duty cycled over at least a second time interval.

12. The user equipment claim 11, wherein the one or more processors are configured to cause the second receive chain to change, between a beginning of the second time interval and an end of the second time interval, from being continuously ON to being duty cycled.

13. A satellite signal processing method, comprising:
measuring signal conditions of satellite positioning signals received using a first receive chain configured to receive and output satellite positioning signals in a first frequency band and a second receive chain configured to receive and output satellite positioning signals in a second frequency band;
determining whether the measured signal conditions meet positioning performance criteria; and
causing, based on the measured signal conditions meeting the positioning performance criteria, the first receive chain to duty cycle between a first state and a second state and the second receive chain to be in the first state during the duty cycling of the first receive chain.

14. The satellite signal processing method of claim 13, wherein the first state is ON and the second state is OFF.

15. The satellite signal processing method of claim 14, further comprising:
causing, based on the measured signal conditions meeting the positioning performance criteria, the first receive chain to duty cycle and the second receive chain to be continuously ON between at least two consecutive ON times of the first receive chain.

16. The satellite signal processing method of claim 14, further comprising:
causing, based on the measured signal conditions failing to meet the positioning performance criteria, the first receive chain and the second receive chain to be continuously ON.

17. The satellite signal processing method of claim 14, wherein the measured signal conditions comprise occurrence of cycle slips on the first frequency band or the second frequency band, wherein the method further comprises:
causing, based on the measured signal conditions comprising the occurrence of the cycle slips meet the positioning performance criteria, the first receive chain to duty cycle and the second receive chain to be continuously ON between consecutive ON times of the first receive chain; and
causing, based on the measured signal conditions comprising the occurrence of the cycle slips fail to meet the positioning performance criteria, the first receive chain and the second receive chain to be continuously ON.

18. The satellite signal processing method of claim 17, wherein the measured signal conditions comprise a combination of the occurrence of the cycle slips, strengths of the satellite positioning signals received on the first frequency band or the second frequency band and elevations of satellite vehicles acquired using the first receive chain or the second receive chain, wherein the method comprises:
causing, based on the measured signal conditions comprising the combination meet the positioning performance criteria, the first receive chain to duty cycle and the second receive chain to be continuously ON between consecutive ON times of the first receive chain; and
causing, based on the measured signal conditions comprising the combination fail to meet the positioning performance criteria, the first receive chain and the second receive chain to be continuously ON.

19. The satellite signal processing method of claim 14, further comprising:
causing, based on the measured signal conditions meet the positioning performance criteria, the first receive chain to duty cycle and the second receive chain to be continuously ON for at least three consecutive ON times of the first receive chain.

20. The satellite signal processing method of claim 14, further comprising:
causing, based on the measured signal conditions meeting the positioning performance criteria, each of the first ON times of the first receive chain to at least partially overlap with a corresponding second ON time of the second receive chain.

21. The satellite signal processing method of claim 14, further comprising:
measuring signal conditions of the satellite positioning signals in the first frequency band and the second frequency band over at least a first time interval;
determining whether the measured signal conditions over at least the first time interval meet the positioning performance criteria; and
causing, based on the measured signal conditions over the at least first time interval failing to meet the positioning performance criteria, the first receive chain to change from being duty cycled to being continuously ON over at least a second time interval.

22. The satellite signal processing method of claim 21, wherein causing the first receive chain to change comprises: causing the first receive chain to change, between a beginning of the second time interval and an end of the second time interval, from being duty cycled to being continuously ON.

23. The satellite signal processing method of claim 14, further comprising:
measuring signal conditions of the satellite positioning signals in the first frequency band and the second frequency band over at least a first time interval;
determining whether the measured signal conditions over at least the first time interval meet the positioning performance criteria; and
causing, based on the measured signal conditions over the at least first time interval meeting the positioning performance criteria, the second receive chain to change from being continuously ON to being duty cycled over at least a second time interval.

24. The satellite signal processing method of claim 23, wherein causing the second receive chain to change comprises: causing the second receive chain to change, between a beginning of the second time interval and an end of the second time interval, from being continuously ON to being duty cycled.

25. A user equipment, comprising:
means for measuring signal conditions of satellite positioning signals received using a first receive chain configured to receive and output satellite positioning signals in a first frequency band and a second receive chain configured to receive and output satellite positioning signals in a second frequency band;
means for determining whether the measured signal conditions meet positioning performance criteria; and
means for, causing, based on the measured signal conditions meeting the positioning performance criteria, the first receive chain to duty cycle between a first state and a second state and the second receive chain to be in the first state during the duty cycling of the first receive chain.

26. The user equipment of claim 25, wherein the first state is ON and the second state is OFF.

27. The user equipment of claim 26, further comprising:
means for causing, based on the measured signal conditions meeting the positioning performance criteria, the first receive chain to duty cycle and the second receive chain to be continuously ON between at least two consecutive ON times of the first receive chain.

28. A non-transitory, processor-readable storage medium comprising processor-readable instructions to cause one or more processors of a user equipment to:
measure signal conditions of satellite positioning signals received using a first receive chain configured to receive and output satellite positioning signals in a first frequency band and a second receive chain configured to receive and output satellite positioning signals in a second frequency band;
determine whether the measured signal conditions meet positioning performance criteria; and
cause, based on the measured signal conditions meeting the positioning performance criteria, the first receive chain to duty cycle between a first state and a second state and the second receive chain to be in the first state during the duty cycling of the first receive chain.

29. The medium of claim 28, wherein the first state is ON and the second state is OFF.

30. The medium of claim 29, further comprising:
cause, based on the measured signal conditions meeting the positioning performance criteria, the first receive chain to duty cycle and the second receive chain to be continuously ON between at least two consecutive ON times of the first receive chain.
